(19) United States
(12) Patent Application Publication
(10) Pub. No.: US 2004/0163234 A1
(43) Pub. Date: Aug. 26, 2004

(54) Resistive vias in a substrate

(76) Inventors: Terry Provo, Indialantic, FL (US); C. Michael Newton, Palm Bay, FL (US)

Correspondence Address: SACCO & ASSOCIATES, PA, P.O. BOX 30999, PALM BEACH GARDENS, FL, 33420-0999, US

(21) Appl. No.: 10/373,153

(22) Filed: Feb. 24, 2003

(51) Int. Cl. H01C 1/012; H01C 17/28

(52) U.S. Cl. 29/620; 29/619; 174/260

(57) ABSTRACT

A rigid substrate board (105) having at least one layer with first (106) and second (107) opposing surfaces. At least one bore is formed in the layer and extending from the first surface (106) to the second surface (107). A resistive material is disposed within the bore and fills the bore to form a resistor (140). Further, a first conductor (115) is disposed on the first surface (106) to form an electrical connection with a first end of the resistor (140), and a second conductor (120) is disposed on the second surface to form an electrical connection with a second end of the resistor. A plurality of resistors (140) can be formed in the substrate layer (105) and interconnected to define a resistive network.

### BACKGROUND OF THE INVENTION

1. Statement of the Technical Field

The inventive arrangements relate generally to the field of resistors, and more particularly to resistors integrated into a substrate.

2. Description of the Related Art

Thick-film resistors are commonly employed in hybrid electronic circuits to provide a wide range of resistor values for use on printed circuit boards (PCBs), in flexible circuits, or on ceramic or silicon substrates. Such resistors are typically formed using deposition techniques known in the art, for example using a thick film screen printing process to deposit a resistive ink, or paste, on a substrate. Resistive thick-film inks are typically composed of an electrically conductive material, typically a Metal Oxide, along with glass frit components, disposed in an organic vehicle or polymer matrix. Further, various additives are typically used to adjust the electrical properties of the inks. After printing, the thick-film ink is typically heated to dry the ink and convert it into a suitable film that adheres to the substrate. The heating process also burns off the organic vehicle, sinters the metal and glass components and/or cures the polymer matrix material.

Compared to many other deposition processes, screen printing is a relatively crude process. Conventional screen printing techniques generally employ a template, referred to as a screening mask, with apertures bearing the positive image of the resistor to be created. The template is usually placed above and in close proximity to the surface of the substrate on which the resistor is to be formed. The mask is then loaded with the resistive ink, and a squeegee blade is drawn across the surface of the mask to press the ink through the apertures and onto the surface of the substrate. Accordingly, control of the width, length and thickness of the resistor during the screen printing process is particularly challenging and resistor dimensions can vary significantly.

Since the electrical resistance of a thick-film resistor is dependent on the precision with which the resistor is produced, it is particularly difficult to fabricate thick-film resistors having close tolerances. Moreover, the control of resistor width, length, and thickness is fundamentally limited by the relatively coarse mesh of the screening mask and by ink flow after deposition. Hence, screen printed thick-film resistors are typically limited to dimensions of about one millimeter, which is larger than many chip resistors. Consequently, as-fired thick-film resistor tolerances are usually limited to approximately 20% to 30%. Thick-film resistors can be laser trimmed to improve resistance tolerances, but laser trimming adds cost, requires additional surface area and may require keep out zones on the layers below the resistor, all of which hinders miniaturization of electronic circuits.

### SUMMARY OF THE INVENTION

The present invention relates to a circuit board substrate with integrated resistive components and a method of manufacturing the same. A rigid substrate board is provided having at least one layer with first and second opposing surfaces. At least one bore is formed in the layer, extending from the first surface to the second surface. A resistive material is disposed within the bore and fills the bore to form a resistor. A first conductor is then disposed on the first surface to form an electrical connection with a first end of the resistor, and a second conductor disposed on the second surface to form an electrical connection with a second end of the resistor.

A plurality of the resistors can be formed in the layer and interconnected to define a resistive network. The first conductor can electrically connect the first end of the first resistor to an end of at least a second resistor exposed at the first surface. The second conductor can electrically connect the second end of the first resistor to an end of a third resistor exposed at the second surface. Further, a third conductor can be disposed on the first surface to form an electrical connection with at least a second end of the third resistor.

A second layer can be disposed on the first surface and at least one bore can be formed the second layer. The bore can extend from a third surface to a fourth surface defining opposing sides of the second layer. A conductive material can be disposed within the bore to provide an electrical connection to one or more of the resistors on the first layer. Further, a resistive material can be disposed within the bore to provide a resistor in series with one or more of the resistors on the first layer.

### BRIEF DESCRIPTION OF THE DRAWINGS

FIGS. 1A-1C are a series of cross sectional views showing a method of forming vias in a substrate in accordance with the present invention.

FIG. 2 is a cross sectional view of a substrate cross section wherein the substrate includes buried resistors in accordance with the present invention.

FIG. 3 is a flow chart of a method of manufacturing buried resistors in a substrate in accordance with the present invention.

### DETAILED DESCRIPTION OF THE PREFERRED EMBODIMENTS

The present invention provides a substrate having resistors formed within vias in a substrate and more particularly in a circuit board substrate. The resistors can be connected in series and in parallel to attain desired resistance values. Notably, since the resistors are formed within the substrate, a greater amount of substrate surface area is available for positioning of other components. Moreover, the size of a substrate can be reduced since area that would normally be used by surface mounted resistors is no longer required.

Significantly, the resistors formed within vias can be manufactured with much higher tolerances than other types of compact resistors. Higher manufacturing tolerances can be maintained because the diameter of vias and the thickness of the substrate can be accurately controlled. Hence, costly processes that are sometimes used to adjust resistor values, such as laser trimming, can be avoided. Moreover, since resistors formed within vias only contact the substrate at the via perimeter, interactions between the resistors and the surrounding substrate are minimized. Further, print quality and accuracy of conductor placement will have an insignificant impact on resistor tolerances. Accordingly, resistors formed within substrate vias can be manufactured more economically and with better quality than other types of low tolerance resistors.

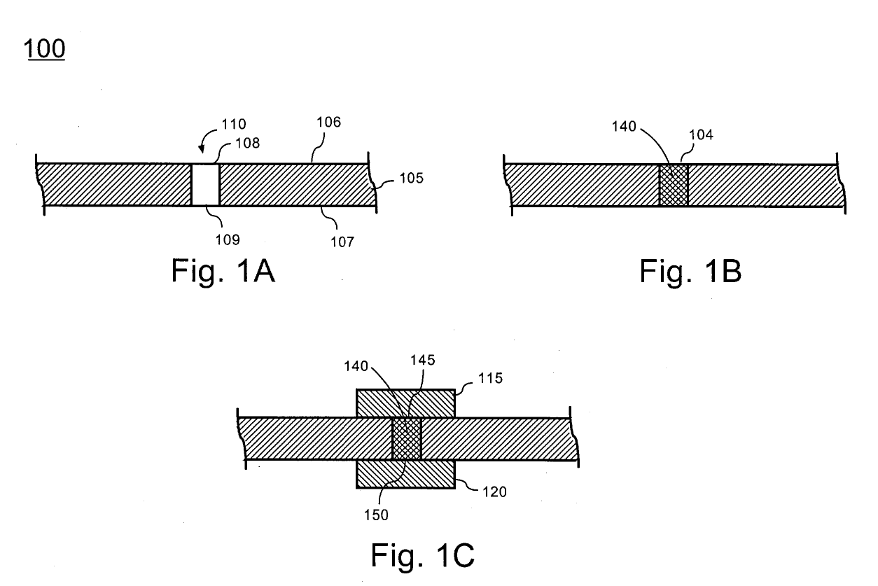

Referring to FIG. 1A, a cross-sectional view is shown of a substrate. The substrate includes a first substrate layer 105 having opposing surfaces 106, 107. The first substrate layer 105 can be formed from any substrate material wherein vias can be formed. For example, the substrate can be formed from ceramic material, such as low temperature co-fired ceramic (LTCC), or a semiconductor material, such as silicon or germanium. Nonetheless, the invention is not so limited and other substrate materials can be used.

One or more vias 110 can be formed by creating bores which extend through the first substrate layer, thereby defining a first opening 108 in the first side of the first substrate layer and a second opening 109 in the second side of the first substrate layer. Many techniques are available for forming bores in a substrate layer. For example, in some substrates, such as ceramic substrates, bores can be formed by laser cutting holes through the substrate or mechanically punching the holes. In other substrates, for example silicon, bores can be etched into the substrate layer using known etching techniques. In a preferred arrangement, the tolerance of the cross-sectional area of each via is tightly controlled.

The vias can be formed so that each via has a same cross sectional profile, or the size of the vias can be selectable so that each via has an optimum cross sectional area to achieve a desired resistance value once the vias have been filled. Vias also can be overlapped to form a larger via with an increased cross sectional area. Further, vias can be formed to have any desired shape. For instance, a via can be formed to have a cylindrical wall profile to maintain a constant cross sectional area throughout the length of the via, or a trapezoidal wall profile can be used to vary the cross sectional area over the length of the via.

After the vias 110 have been formed, they can be filled as shown in FIG. 1B with a material 104 having electrically resistive characteristics (resistive material) to form buried resistors 140. For example, the buried resistors can be formed to have resistance values ranging from under 10 Ω to over 100 MΩ. The resistive material can be any material having electrically resistive properties and that can be used to fill a via. In one arrangement, a solid resistive material, for example a carbon based resistive material, can be formed in the shape of cylinders that fit into vias 110. In another arrangement, a paste, liquid or semi-liquid resistive material can be used to fill the vias 110. For example, the resistive material can be a ruthenium oxide (RuO₂) based resistive material. The use of RuO₂ as a resistive material is known to the skilled artisan and has shown to exhibit superior resistor properties, such as electrical and mechanical stability as well as resistance to environmental elements, such as humidity. RuO₂ is commonly used in thick film inks that are made for printing resistors onto a surface, but such inks tend to shrink at a rate disproportionate with the substrate material shrink rate when the inks are dried. However, proportions of solids, vehicles and fillers in the resistive material, for example glass fillers, can be adjusted to modify the shrink rate of the resistive material. Component particle size can also be selected to achieve desired shrinkage characteristics. Accordingly, the shrink rate can be customized to match the shrink rate of the substrate.

Characteristics of resistive material can be used to adjust its resistivity. For example, the characteristics of RuO₂ can be modified in the resistive material. Accordingly, the resistivity can be adjusted to result in a buried resistor having any standard resistor value. Further, resistivity can be adjusted to result in custom resistance values, for example, 25.4 kΩ or 1.65 MΩ.

Referring now to FIG. 1C, one or more conductors 115 can be deposited on the top of the first substrate layer over the top of the vias 110, making electrical contact with the buried resistor 140. Further, one or more conductors 120 can be deposited on the bottom of the first substrate layer, under the bottom of the vias 110, also making electrical contact with the buried resistor 140. The conductors can be formed of any suitably conductive material. For example a metal or metal alloy can be used for this purpose. Techniques for deposition of such conductors are well known in the art. Notably, if the conductors 115, 120 are disposed so that the top conductor 115 contacts the entire top surface 145 of the buried resistor 140, and the bottom conductor 120 contacts the entire bottom surface 150 of the buried resistor 140, the resistor's current carrying capability can be maximized.

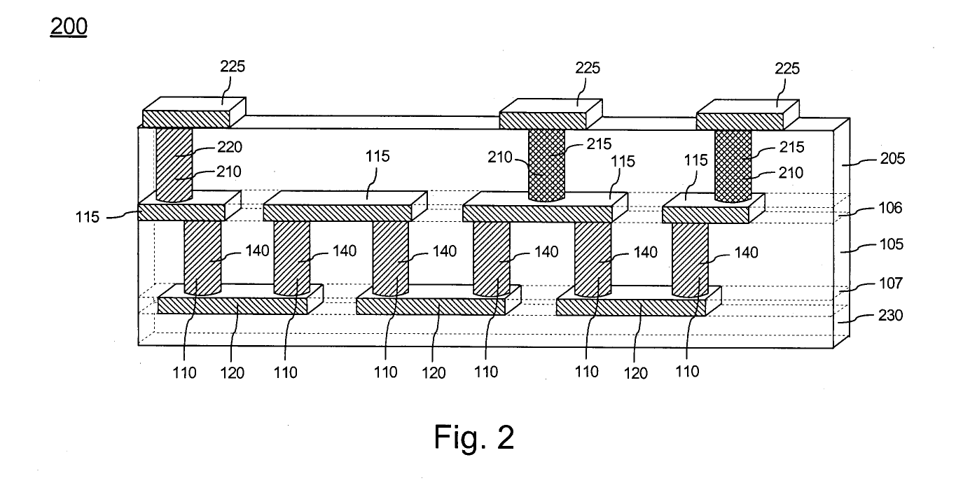

Referring now to FIG. 2, it can be seen that the conductors 115 can alternatively be deposited on a bottom side of a second substrate layer 205 and positioned so that the conductors 115 make electrical contact with the buried resistors 140 when the first substrate layer 105 and second substrate layer 205 are joined together. Likewise, the conductors 120 can be deposited on a top of a third substrate layer 230, if provided, and positioned so that the conductors 120 make electrical contact with the buried resistors 140 when the first substrate layer 105 and third substrate layer 230 are joined together. Notably, the third substrate layer 230 is not required and the conductors 120 can remain exposed for device connections to the bottom surface 107 of the first substrate layer 105.

Various methods can be used to join the substrate layers. For example, the layers can be laminated together using a variety of lamination methods. In one method using ceramic substrate layers, the substrate layers can be stacked and hydraulically pressed with heated platens. For example, a uniaxial lamination method presses the ceramic substrate layers together at 3000 psi for 10 minutes using plates heated to 70° C. The ceramic substrate layers can be rotated 180° following the first 5 minutes. In an isotatic lamination process, the ceramic substrate layers are vacuum sealed in a plastic bag and then pressed using heated water. The time, temperature and pressure can be the same as those used in the uniaxial lamination process, however, rotation after 5 minutes is not required. Once laminated, the structure can be fired inside a kiln on a flat tile. For example, the ceramic substrate layers can be baked between 200° C. and 500° C. for one hour and a peak temperature between 850° and 875° can be applied for greater than 15 minutes. After the firing process, post fire operations can be performed on the ceramic substrate layers.

The conductors 115 and conductors 120 can be positioned so that they provide an electrically continuous connection between two or more buried resistors 140. For example, the conductors can be arranged as shown in FIG. 2 to connect a plurality of buried resistors 140 in series and/or in parallel to form a resistor circuit. Accordingly, if the buried resistors 140 each have a particular nominal value, they can be connected in parallel to achieve lower values, or in series to achieve higher values. Further, series and parallel buried resistor combinations can be used to achieve other desired resistance values, for example multiple resistors can be combined in resistor circuits having both series and parallel combinations. This method has an advantage over a method wherein a different resistive filler is mixed for each individual resistor value, especially if a particular circuit incorporates a wide range of resistor values. Notably, it is much less time consuming and much more cost effective to apply a single resistive filler to a substrate than to mix a wide range of resistive filler mixtures. Moreover, the risk of an incorrect resistive filler being applied to a via is reduced when all of the vias are filled with the same resistive filler.

Vias can also extend through the second substrate layer 205 or third substrate layer 230. For example, in FIG. 2 vias 210 are shown in the second substrate layer 205. The vias 210 can be filled with a resistive material 220 of a same or different resistivity, as described above relative to vias 110. For example, vias 210 in the second substrate layer 205 can be filled with a resistive material to form 1 kΩ resistors while the first substrate layer 105 is filled with a different resistive material which is used to form 100 kΩ resistors. Further, the thickness of the second substrate layer 205 and/or the third substrate layer 230 can be different than the thickness of the first substrate layer 105. Accordingly, length of the buried resistors can be varied between layers to provide another method of controlling resistance values. For example, the second substrate layer 205 can be 50% thicker than the first substrate layer. Assuming that a second via in the second substrate layer 205 has the same cross sectional area as a first via in the first substrate layer 105, and that the first and second vias are filled with the same resistive material to form buried resistors, the buried resistor formed in the second via will have a resistance that is approximately 50% higher than the buried resistor formed in the first via.

In lieu of being filled with resistive material, the vias 210 also can provide a path for a conductor 215. For example, a conductive coating can be deposited on the walls of the vias 210, conductive pins can be inserted through the vias 210, or the vias can be filled with a conductive material, as would be known to the skilled artisan. Further, conductors 225 can be deposited on a top side of the third substrate layer, thereby providing an electrical contact with the conductors 215 or resistor(s) 220 in the vias 210. Thus, the conductors 215 and/or resistor(s) 220 can be used to provide an electrically continuous connection between the conductors 225 and the conductors 115. Accordingly, the conductors 215 and/or resistor(s) 220 can be arranged to provide multiple taps from the resistive circuit, thereby providing a variety of resistance values from a single resistive circuit.

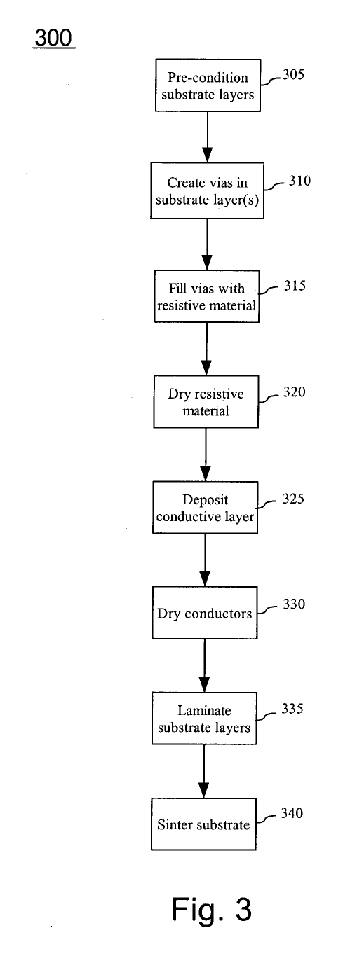

A method 300 of manufacturing buried resistors in a substrate is shown in FIG. 3. Referring to step 305, substrate layers can be preconditioned before being used in a fabrication process. For example, if the ceramic substrate material is used, the substrate can be baked at an appropriate temperature for a specified period of time or left to stand in a nitrogen dry box for a specified period of time. Common preconditioning cycles for ceramic material are 120° C. for 20-30 minutes or 24 hours in a nitrogen dry box. Both preconditioning process are well known in the art of ceramic substrates.

Referring to step 310, one or more bores can be created in each of the substrate layers 105, 205, 230 that are to incorporate vias. As previously noted, many techniques are available for forming bores in a substrate layer, such as mechanically punching, laser cutting, or etching holes into the substrate layer. The bores or vias can then be filled with a resistive material using a mylar or metal mask and a printing process to form buried resistors as shown in step 315. In one arrangement, vacuum can be applied to the first substrate layer through a porous stone to aid via filling.

Referring to step 320, the resistive material then can be dried. For example, a drying process can include baking the first substrate layer at 120° C. for 5 minutes. If the resistive material has a greater shrinking coefficient than the substrate material in the substrate layers, thereby leaving some empty space in the vias after drying, additional resistive material can be added to the vias to fill the empty space. The substrate layers can again be baked. This process can be repeated until the vias are completely filled with resistive material to form the buried resistors. At this point conductive material can be added to vias which are selected to be conductive vias. For example, a solid conductor can be inserted into the selected vias.

Referring to step 325, conductive layers then can be deposited on the first substrate layer 105, the second substrate layer 205, and/or the third substrate layer 230. For example, a conventional thick film screen printer, such as a standard emulsion thick film process, can be used to deposit conductive layers on the desired substrate layers. The substrate layer(s) then can be baked to dry the conductive traces, as shown in step 330, for example at 120° C. for 5 minutes for LTCC.

Referring to step 335, the second and third substrate layers 205 and 230 can be laminated to the first substrate layer 105 after appropriate preconditioning and drying of circuit traces. A variety of techniques for laminating substrates are known to those skilled in the art of substrate manufacturing, as previously discussed. The laminated substrate structure then can be sintered, as shown in step 340. For example, in the case that the substrate is LTCC, the first and second substrate layer combination can be sintered at approximately 850° C. to 900° C. for 15 minutes.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

1. A method for manufacturing resistors in a substrate, comprising the steps:
forming at least one bore in a circuit board substrate layer having opposing first and second sides, said bore having a first opening in said first side of said substrate layer and a second opening in said second side of said substrate layer;
filling said bore with a resistive material to form a resistor; and
depositing a first conductor over said first opening and depositing a second conductor over said second opening, wherein said first conductor and said second conductor are in electrical contact with respective first and second ends of said resistor.

2. The method of claim 1, further comprising the steps:
forming at least a second bore in said substrate layer; and
filling said second bore with a resistive material to form a second resistor;
wherein said first conductor electrically connects said first resistor and said second resistor.

3. The method of claim 2, wherein said first and second resistors are connected in series.

4. The method of claim 2, wherein said first and second resistors are connected in parallel.

5. The method of claim 1, further comprising the steps:
drying said resistive material; and
sintering said substrate after said drying step.

6. The method of claim 1, further comprising the steps:
forming at least a second bore in a second substrate layer;
filling said second bore with a resistive material to form a second resistor; and
positioning said second substrate layer on said first substrate layer so that said first conductor electrically connects said first resistor and said second resistor.

7. The method of claim 1, further comprising the steps:
forming at least a second bore in a second substrate layer;
filling said second bore with a conductive material to form a third conductor;
positioning said second substrate layer on said first substrate layer so that said first conductor electrically connects said first resistor and said third conductor.

8. The method of claim 1, further comprising the step of selecting a material for said substrate layer from the group consisting of a ceramic and a semiconductor.

9. The method of claim 1, further comprising the step of selecting said substrate layer material to be a low temperature co-fired ceramic.

10. A circuit board substrate with integrated resistive components, comprising:
a rigid substrate board having at least one layer with first and a second opposing surfaces;
at least one bore formed in said layer and extending from said first surface to said second surface;
a resistive material disposed within and filling said at least one bore to form a resistor;
a first conductor disposed on said first surface and forming an electrical connection with a first end of said resistor, and a second conductor disposed on said second surface and forming an electrical connection with a second end of said resistor exposed at said second surface.

11. The circuit board substrate according to claim 10 further comprising a plurality of said resistors formed in said; layer.

12. The circuit board substrate according to claim 11, wherein said first conductor electrically connects said first end of said first resistor to an end of at least a second one of said resistors exposed at said first surface.

13. The circuit board substrate according to claim 12 wherein said second conductor electrically connects said second end of said first resistor to an end of a third one of said resistors exposed at said second surface.

14. The circuit board substrate according to claim 13 wherein a third conductor is disposed on said first surface and forms an electrical connection with at least a second end of said third resistor exposed at said first surface.

15. The circuit board substrate according to claim 12 further comprising a second layer disposed on said first surface and at least one bore formed in said second layer and extending from a third surface to a fourth surface defining opposing sides of said second layer.

16. The circuit board substrate according to claim 15 further comprising a conductive material disposed within said bore to provide an electrical connection to one or more of said resistors on said first layer.

17. The circuit board substrate according to claim 15 further comprising a resistive material disposed within said bore to provide a resistor in series with one or more of said resistors on said first layer.

18. The circuit board substrate according to claim 10 further comprising:
a plurality of said resistors formed in said first layer interconnected to define a resistive network;
a second layer disposed on said first surface;
a plurality of bores formed in said second layer and extending from a third surface to a fourth surface;
a conductive material disposed within said bores to provide a series of electrical contacts at tap points within said resistive network.

19. The circuit board substrate according to claim 18 further comprising at least a second conductor disposed on said third surface and forming an electrical connection with one of said resistors disposed on said first layer.

20. The circuit board substrate according to claim 18 further comprising a plurality of conductors disposed on said third surface to provide a plurality of taps within said resistive network.
